(19) United States
(12) Patent Application Publication
(10) Pub. No.: US 2014/0157346 A1
(43) Pub. Date: Jun. 5, 2014

(54) METHODS, DEVICES AND SYSTEMS FOR PEER-TO-PEER VIDEO CONTENT DISTRIBUTION

(71) Applicant: ClearOne Communications, Inc., Salt Lake City, UT (US)

(72) Inventors: Avishay Ben Natan, Rishon LeZion (IL); Tom Searcy, Corvallis, OR (US)

(73) Assignee: ClearOne Communications, Inc., Salt Lake City, UT (US)

(21) Appl. No.: 14/095,853

(22) Filed: Dec. 3, 2013

Related U.S. Application Data
(60) Provisional application No. 61/732,803, filed on Dec. 3, 2012.

(51) Int. Cl. H04N 21/41; H04N 21/222

(52) U.S. Cl. CPC H04N 21/4104; H04N 21/2223
USPC 725/117

(57) ABSTRACT

Methods, apparatuses, and devices for distributing video content in a peer-to-peer network. A video content source outputs video content to a first display device of a plurality of display devices. Each of the plurality of display devices is configured to automatically detect and download video content from one or more others of the plurality of display devices.

### PRIORITY CLAIM

This application claims the benefit of the filing date of U.S. Provisional Patent Application Ser. No. 61/732,803, filed Dec. 3, 2012, for “METHODS, DEVICES AND SYSTEMS FOR PEER-TO-PEER VIDEO DISTRIBUTION.”

### TECHNICAL FIELD

The present disclosure relates to distributing video content for digital signage and, more particularly, to a plurality of display devices.

### BACKGROUND

Conventional multiple-display video content distribution systems typically utilize wired networks. A conventional multiple-display system 100 is illustrated in FIG. 1. In the conventional multiple-display system 100, a central server 102 publishes video content to one or more player devices 104. Each player device 104 delivers the video content as a video signal to a transmitter device 106 through a video cable 112, such as, for example, a VGA, DVI, or HDMI cable.

Each transmitter device 106 converts the video signal into a form that may be transmitted through a data cable 108 to one or more receiver devices 110. Typical data cables 108 used for digital signage are Category 5 (CATS) cables carrying VGA over CATS signals, network cables, or fiber network cables carrying an internet protocol (IP) stream.

Each receiver device 110 converts the video content back into a video signal, and delivers the video signal to a display device 114, such as a monitor or television, through another video cable 112. Each display device 114 receiving the video signal displays the video content delivered by the video signal.

As each display device 114 is connected to a player device 104 through a series of cables and devices, a player device 104 must be located relatively near to each display device 114. In situations where at least two display devices 114 are relatively remote from each other, or where the number of display devices 114 exceeds the number of output ports on the transmitter device 106, more than one player device 104 may be needed.

Typically, licensing restrictions limit the number of player devices 104 video content may be published to. Specifically, licensing restrictions limit the number of “content channels” 116 in a system. A content channel 116, in the context of the conventional multiple-display system 100, would include all the display devices 114 connected to the same player device 104, and displaying the same video content.

The conventional multiple-display system 100 of FIG. 1 includes two content channels 116-1, 116-2. Content channel 116-1 includes player device 104-1 and display device 114-1. Content channel 116-2 includes player device 104-2 and display devices 114-2, 114-3, and 114-4. Even if it is desired to transmit the same video content on both content channel 116-1 and content channel 116-2, a license would have to be negotiated to pay for two content channels 116. As a result, customers in the digital signage field often pay per player device 104, not necessarily per video content.

As previously pointed out, the conventional multiple-display system 100 may necessitate deploying multiple player devices 104, which can be expensive. Other required equipment, such as transmitter devices 106, receiver devices 110, data cables 108, and video cables 112 add expense. Furthermore, installation and maintenance of the various cables and devices of the conventional multiple-display system 100 can be expensive and complicated.

### BRIEF SUMMARY

Embodiments discussed herein include methods, devices and systems for distributing video content in a peer-to-peer network.

In some embodiments, the present disclosure comprises a video content distribution system. The video content distribution system includes a plurality of video display transceiver devices and a video content source. Each of the plurality of video display transceiver devices is configured to establish communication with one or more others of the plurality of video display transceiver devices through a network. Each of the plurality of video display transceiver devices is also configured to automatically detect and download video content stored on the one or more others of the plurality of video display transceiver devices. The video content source is configured to provide video content to at least a first video display transceiver device of the plurality of video display transceiver devices.

In other embodiments, the present disclosure comprises a method of distributing video content. The method includes publishing video content to a first video display transceiver device. The method also includes storing the video content to a storage device of the first video display transceiver device. The method further includes automatically detecting the video content stored on the storage device of the first video display transceiver device with at least a second video display transceiver device. The method also includes downloading the video content to a storage device of the second video display transceiver device from the first video display transceiver device.

In other embodiments, the present disclosure comprises a video display transceiver device. The video display transceiver device includes a display device and a control device. The display device includes an input configured to receive a video signal and a display element configured to display video content carried to the input by the video signal. The control device is operably coupled to the display device. The control device includes a transceiver, a storage device, and a processor. The transceiver is configured to send and receive video content through a network. The storage device is configured to store video content. The processor is operably coupled to the transceiver and the storage device. The processor is configured to cause the control device to deliver the video signal to the input of the display device. The processor is also configured to cause the control circuit to automatically detect and download video content stored on one or more other video display transceiver devices.

### BRIEF DESCRIPTION OF THE SEVERAL VIEWS OF THE DRAWINGS

FIG. 1 is a simplified block diagram of a conventional multiple-display video content distribution system;

FIG. 2 is a simplified block diagram of a particular embodiment of an improved multiple-display video content distribution system; and

FIG. 3 is a simplified block diagram of an embodiment of a video display transceiver device in communication with a network.

### DETAILED DESCRIPTION

In the following detailed description, reference is made to the accompanying drawings which form a part hereof, and in which is shown by way of illustration specific embodiments in which the present disclosure may be practiced. These embodiments are described in sufficient detail to enable those of ordinary skill in the art to practice the present disclosure. It should be understood, however, that the detailed description and the specific examples, while indicating examples of embodiments of the present disclosure, are given by way of illustration only and not by way of limitation. From this disclosure, various substitutions, modifications, additions rearrangements, or combinations thereof within the scope of the present disclosure may be made and will become apparent to those of ordinary skill in the art.

In accordance with common practice the various features illustrated in the drawings may not be drawn to scale. The illustrations presented herein are not meant to be actual views of any particular method, device, or system, but are merely idealized representations that are employed to describe various embodiments of the present disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or method. In addition, like reference numerals may be used to denote like features throughout the specification and figures.

Those of ordinary skill in the art would understand that information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

Those of ordinary skill would further appreciate that the various illustrative logical blocks, modules, circuits, and algorithm acts described in connection with embodiments disclosed herein may be implemented as electronic hardware, computer software, or combinations of both. To clearly illustrate this interchangeability of hardware and software, various illustrative components, blocks, modules, circuits, and acts are described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments of the disclosure described herein.

In addition, it is noted that the embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on a computer-readable medium. Computer-readable media includes both computer storage media and communication media including any medium that facilitates transfer of a computer program from one place to another.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements.

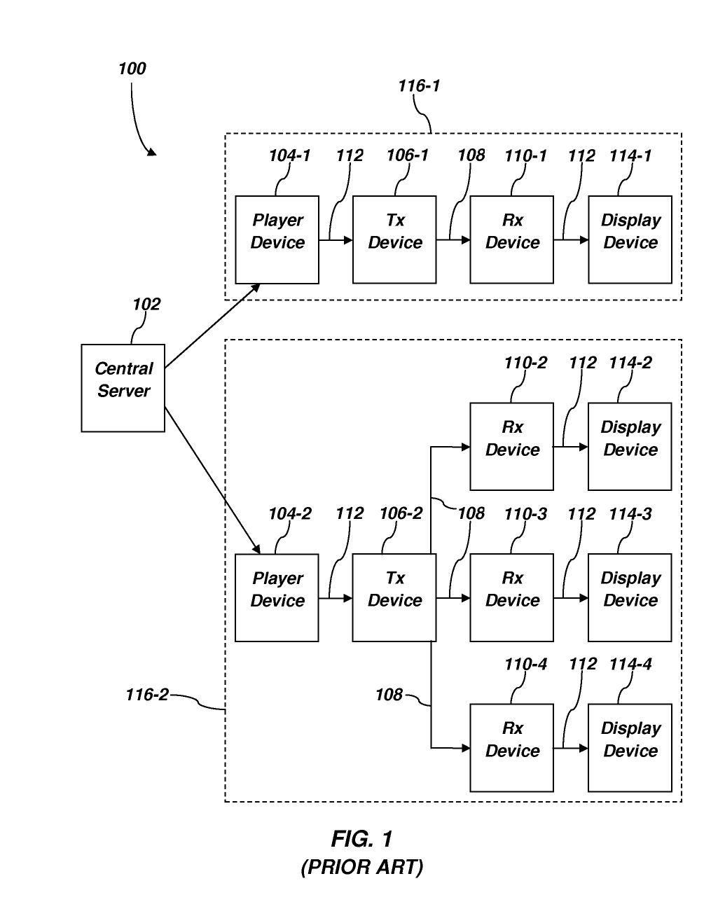

Elements described herein may include multiple instances of the same element. These elements may be generically indicated by a numerical designator (e.g. 110) and specifically indicated by the numerical indicator followed by an alphabetic designator (e.g., 110A) or a numeric indicator preceded by a “dash” (e.g., 110-1). For ease of following the description, for the most part, element number indicators begin with the number of the drawing on which the elements are introduced or most fully discussed. Thus, for example, element identifiers on a FIG. 1 will be mostly in the numerical format 1xx and elements on a FIG. 4 will be mostly in the numerical format 4xx.

Embodiments of the present disclosure include systems, methods and devices for distributing video content in a peer-to-peer network. It should be noted that while the utility and application of the various embodiments of the present disclosure are described with reference to the digital signage field, the present disclosure also finds application to any environment where distributing video content in a peer-to-peer network may be helpful or desirable.

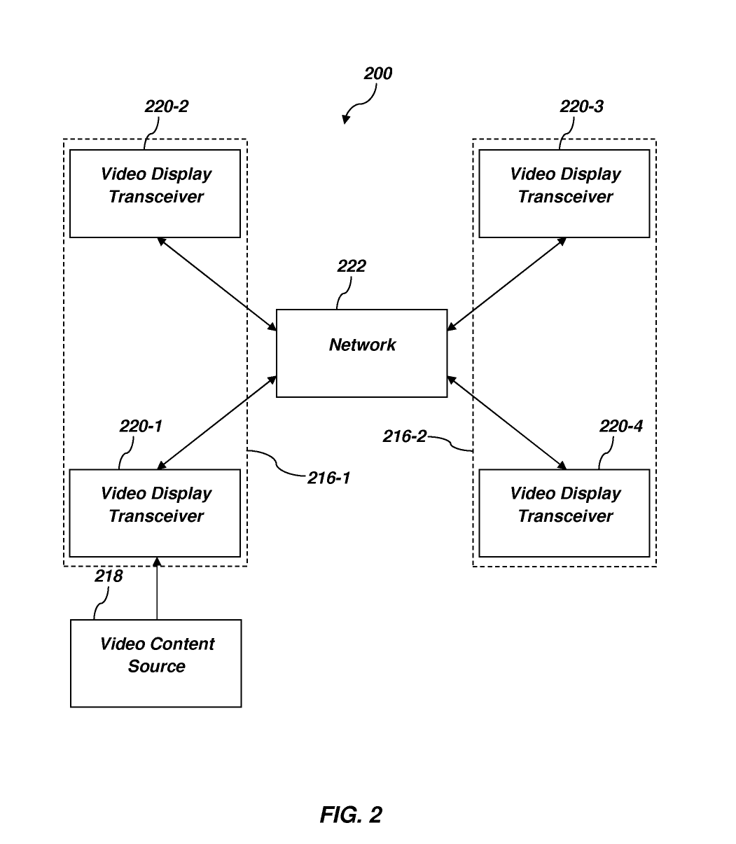

FIG. 2 is a simplified block diagram of an improved multiple-display system 200. The multiple-display system 200 may include a network 222, a video content source 218, and a plurality of video display transceiver devices 220.

The network 222 may comprise any one or combination of a personal area network (PAN), a local area network (LAN), a wide area network (WAN), or other suitable network. Also, the network 222 may be configured as a wireless network, such as “wifi” and cellular networks, a wired network, or combinations thereof.

The video content source 218 may be any of a desktop computer, a notebook computer, a tablet computer, a cellular telephone, a personal digital assistant (PDA), and any other device configured to execute software and communicate with one or more of the plurality of video display transceiver devices 220.

The video content source 218 may be configured to publish video content to one or more of the video display transceiver devices 220. By way of non-limiting example, the video content source 218 may publish video content to the one or more video display transceiver devices 220 through a cable. Also by way of non-limiting example, the video content source 218 may publish video content to the one or more video display transceiver devices 220 through the network 222, or another network (not shown).

Also by way of non-limiting example, the video content source 218 may be configured as a server to be located relatively proximate to the plurality of video display transceiver devices 220. Alternatively, the video content source 218 may be configured as a hosted server to be located remote from the plurality of video display transceiver devices 220.

The video content source 218 may be configured to execute a digital signage management software program. The digital signage management software program may be configured to operate as a cross-platform software program. By way of non-limiting example, the management software program may be configured to operate on any one or more of a Windows operating system, an Apple OS X operating system, a Unix operating system, a Linux operating system, an Android operating system, and other appropriate operating systems.

The digital signage management software program may also be configured to operate as a web application that may be accessed from any device that connects to the internet and operates web-browsing software. Alternatively, the digital signage management software program may operate as an application that is executed on the video content source 218. Furthermore, the digital signage management software program may be configured to run, in part, as a web application and, in part, as an application that is executed on the video content source 218.

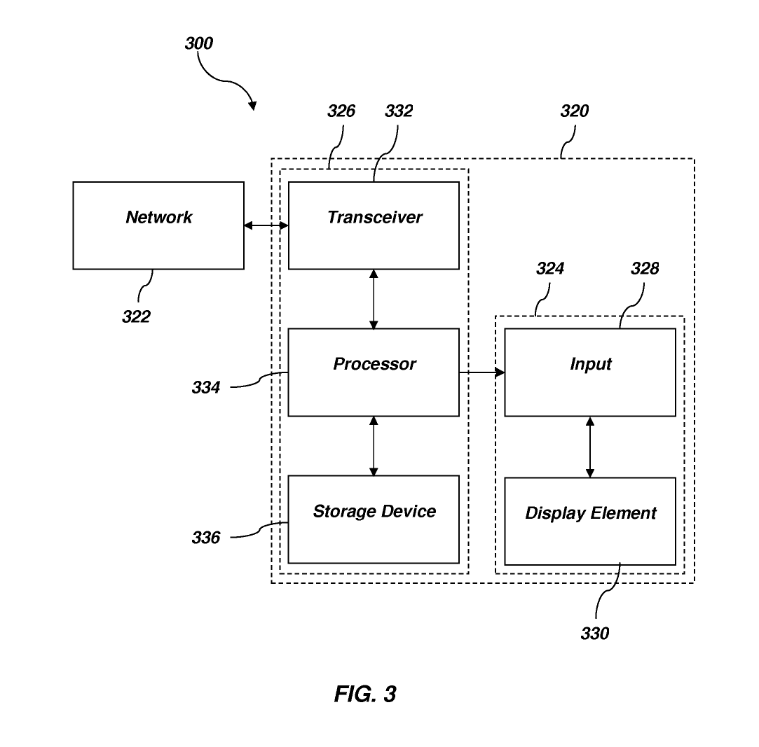

The plurality of video display transceiver devices 220 may each be configured to send and receive video content through the network 222. A more detailed discussion of the plurality of video display transceiver devices 220 is provided below with respect to FIG. 3. The plurality of video display transceiver devices 220 may be configured in a peer-to-peer network through the network 222. Also, the plurality of video display transceiver devices 220 may be configured in one or more groups comprising one or more content channels 216. Furthermore, communication between the plurality of video display transceiver devices 220 may be encrypted.

The plurality of video display transceiver devices 220 also may each be configured to display video content. Each of the plurality of video display transceiver devices 220 within a content channel 216 may display the same video content. FIG. 2, by way of non-limiting example, includes two content channels 216-1, 216-2, each of which includes two video display transceiver devices 220. In FIG. 2, for example, content channel 216-1 includes video display transceiver devices 220-1, 220-2, and content channel 216-2 includes video display transceiver devices 220-3, 220-4. The present disclosure is not so limiting, however, and contemplates multiple-display systems with fewer or more content channels 216, and fewer or more video display transceiver devices 220.

By way of non-limiting example, a multiple-display system 200 may include up to hundreds of video display transceiver devices 220 and a single content channel 216. Also by way of non-limiting example, a multiple-display system 200 may include two video display transceiver devices 220 and two content channels 216.

Each of the plurality of video display transceiver devices 220 may be configured to automatically detect and download video content stored on one or more others of the plurality of video display transceiver devices 220. As a result, video content that is published to a first video display transceiver device 220-1 by the video content source 218 may be distributed to the remaining video display transceiver devices 220-2, 220-3, 220-4 without the video content source 218 directly publishing video content to the remaining video display transceiver devices 220-2, 220-3, 220-4.

As a non-limiting example, all video display transceiver devices 220 may automatically detect and download video content from any other video display transceiver device 220, regardless of which content channel 216 it is associated with. Alternatively, the video display transceiver devices 220 may be configured to only automatically detect and download video content from other video display transceiver devices 220 that are part of the same content channel 216.

Video content published by the video content source 218 may be associated with a particular content channel of the one or more content channels 216. Each of the video display transceiver devices 220 associated with the particular content channel may be configured to display the video content associated with the particular content channel. Each of the video display transceiver devices 220 that are not, however, associated with the particular content channel may be restricted from displaying the video content associated with the particular content channel.

By way of non-limiting example, the video content source 218 of FIG. 2 may publish video content associated with the first content channel 216-1 to the first video display transceiver device 220-1. Video display transceiver devices 220-2, 220-3, and 220-4 may automatically detect and download the video content associated with the first content channel 216-1. Video display transceivers devices 220-1 and 220-2 may display the video content associated with the first content channel 216-1 because video display transceiver devices 220-1 and 220-2 are associated with content channel 216-1. Video display transceiver devices 220-3 and 220-4, however, may not display the video content associated with the first content channel 216-1 because video display transceiver devices 220-3 and 220-4 are associated with content channel 216-2, not content channel 216-1.

The digital signage management software program of the content source may be configured to arrange schedules for video content to be published to the one or more content channels 216. Also, the digital signage management software program may be configured to associate the one or more content channels 216 with one or more playlists of video content.

As the video content source 218 need only publish video content to a first video display transceiver device 220-1 to distribute the video content to all the video display transceiver devices 220 in a content channel 216, multiple player devices 104 and other hardware common in conventional multiple-display systems 100 (FIG. 1) are unnecessary. Consequently, the cost and complication of hardware and installation of the multiple-display system 200 may be significantly less than the cost and complication of the conventional multiple-display system 100.

Also, video display transceiver devices 220 that may be located too far from each other to connect to the same conventional player device 104 (FIG. 1) may be part of the same content channel 216 in the multiple-display system 200 of the present disclosure. Furthermore, even if there were more video display transceiver devices 220 than outputs on a single conventional player device 104, all the video display transceiver devices 220 may be part of the same content channel 216 in the multiple-display system of the present disclosure. Consequently, instead of the number of content channels 216 utilized by the multiple-display system 200 being driven by the number of player devices 104, as in the conventional multiple-display system 100, the number of content channels 216 of the multiple-display system 200 of the present disclosure may be driven by video content.

FIG. 3 is a simplified block diagram of a portion of a multiple-display system 300 including a video display transceiver device 320 in communication with a network 322, according to a particular embodiment. The video display transceiver device 320 may include a display device 324 and a control device 326. The display device 324 and the control device 326 may be implemented as separate devices configured to operably connect to each other. By way of non-limiting example, the display device 324 may be a television or a monitor, and the control device 326 may be an HDMI stick device. Also by way of non-limiting example, the display device 324 and the control device 326 may be implemented within the same enclosure of a single video display transceiver device 320, such as, for example, a “smart” television.

The display device 324 may include a display element 330 and an input 328. The display element 330 may be configured to display video content that is received through the input 328. By way of non-limiting example, the display element 330 may be any of an LED array, a liquid crystal display, a cathode ray tube display, and a plasma display.

By way of non-limiting example, the input 328 may be configured to receive video content, in the form of a video signal, to the display device 324. By way of non-limiting example, the video signal may be a video graphics array (VGA) signal, a DisplayPort signal, a digital visual interface (DVI) signal, a high-definition multimedia interface (HDMI) signal, a component video signal, a separate video (S-video) signal, a composite video signal, or combinations thereof. If the control device 326 and the display device 324 are integrated in a single video display transceiver device 320, the input 328 may be either a cable, one or more printable circuit board (PCB) traces, or a PCB connector.

Alternatively, if the control device 326 and the display device 324 are integrated separately, the input 328 may be a video input port, such as, by way of non-limiting example, a VGA connector, a DisplayPort connector, a DVI connector, an HDMI connector, a component video connector, an S-video connector, a composite video connector, or combinations thereof.

The control device 326 may operably couple to the input 328 of the display device 324 and deliver the video signal to the display device 324. The control device 326 may also be configured to automatically detect and download video content on one or more other video display transceiver device. The control device 326 may include a processor 334, a transceiver 332, and a storage device 336.

The transceiver 332 may be configured to send and receive data through the network. By way of non-limiting example, the transceiver 332 may include one or more radiative elements for wirelessly communicating with the network 322. Alternatively, the transceiver 332 may include a cable port to carry communication signals between the control device 326 and the network 322.

The storage device 336 may include any one or combination of a random access memory, a computer readable media, a flash memory, and an erasable programmable read only memory, etc. The storage device 336 may be configured to store video content. The storage device 336 may also be configured to store computer executable commands for a video player software application.

The processor 334 may be operably coupled to and control the transceiver 332 and the storage device 336. The processor 334 may be configured to execute the video player software application stored on the storage device 336. By way of non-limiting example, the video player software application may be configured as an Android application if the control device 326 is implemented as an HDMI stick device

Also by way of non-limiting example, the processor 334 may cause the control device 326 to periodically send an inquiry signal to one or more other video display transceiver devices through the network 322 to inquire if new video content has been received. The processor 334 may cause the control device 326 to download the new video content from the one or more other video display transceiver devices responsive to receiving a confirming signal from the one or more other video display transceiver devices. Also, the processor 334 may cause the control device 326 to send a confirming signal to one or more other video display transceiver devices responsive to receiving an inquiry signal from the one or more other video display transceiver devices if the control device 326 has new video content. Furthermore, the processor 334 may be configured to permit the other video display transceiver devices to download the new video content from the video display transceiver device 320.

Alternatively, the processor 334 may cause the control device 326 to notify the other video display transceiver devices that new video content is available responsive to downloading the new video content. The processor 334 may also be configured to cause the control device 326 to upload the new video content to the other video display transceiver devices, or permit the other video display transceiver devices to download the new video content. In still another alternative, the processor 334 may immediately upload the new video content to the other video display transceiver devices responsive to receiving the new video content.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being encompassed within the scope of embodiments encompassed by the disclosure as contemplated by the inventors.

What is claimed is:

1. A video content distribution system, comprising:
a plurality of video display transceiver devices, wherein each of the plurality of video display transceiver devices is configured to establish communication with one or more others of the plurality of video display transceiver devices through a network, each of the plurality of video display transceiver devices configured to automatically detect and download video content stored on the one or more others of the plurality of video display transceiver devices; and
a video content source configured to provide video content to at least a first video display transceiver device of the plurality of video display transceiver devices.

2. The video content distribution system of claim 1, wherein the video content source is configured to execute a management software program.

3. The video content distribution system of claim 2, wherein the management software program is configured to operate on one or more software platform from the group consisting of Microsoft Windows, Apple OS X, Unix, Linux, and Android.

4. The video content distribution system of claim 2, wherein the management software program is configured as a web application that may be accessed by a device with an internet connection and web-browsing software.

5. The video content distribution system of claim 1, wherein the plurality of video display transceiver devices is grouped into one or more content channels, each of the plurality of video display transceiver devices configured to operate as part of one of the one or more content channels.

6. The video content distribution system of claim 5, wherein each of the plurality of video display transceiver devices is configured to operate as part of a single content channel.

7. The video content distribution system of claim 5, wherein the plurality of video display transceiver devices is grouped into a plurality of content channels.

8. The video content distribution system of claim 1, wherein the communication between each of the plurality of video display transceiver devices is encrypted.

9. A method of distributing video content, the method comprising:
publishing video content to a first video display transceiver device;
storing the video content to a storage device of the first video display transceiver device;
automatically detecting the video content stored on the storage device of the first video display transceiver device with at least a second video display transceiver device; and
downloading the video content to a storage device of the second video display transceiver device from the first video display transceiver device.

10. The method of claim 9, further comprising displaying the video content on a display element of the second video display transceiver device.

11. The method of claim 9, wherein automatically detecting the video content stored on the storage device of the first video display transceiver device with the second video display transceiver device comprises periodically sending an inquiry signal from the second video display transceiver device to the first video display transceiver device and receiving a confirming signal from the first video display transceiver device.

12. The method of claim 9, wherein automatically detecting the video content stored on the storage device of the first video display transceiver device with the second video display transceiver device comprises receiving a notification signal at the second video display transceiver device from the first video display transceiver device, the notification signal indicating the presence of the video content on the storage device of the first video display transceiver device.

13. The method of claim 9, further comprising restricting the video content for display to one or more video display transceiver devices associated with a particular content channel.

14. A video display transceiver device, comprising:
a display device, including:
an input configured to receive a video signal; and
a display element configured to display video content carried to the input by the video signal; and
a control device operably coupled to the display device, the control device comprising:
a transceiver configured to send and receive video content through a network;
a storage device configured to store video content; and
a processor operably coupled to the transceiver and the storage device, the processor configured to cause the control device to deliver the video signal to the input of the display device, the processor further configured to cause the control circuit to automatically detect and download video content stored on one or more other video display transceiver devices.

15. The video display transceiver device of claim 14, wherein the video signal is configured as one or more from the group consisting of a video graphics array (VGA) signal, a DisplayPort signal, a digital visual interface (DVI) signal, a high-definition multimedia interface (HDMI) signal, a component video signal, a separate video (S-video) signal, and a composite video signal.

16. The video display transceiver device of claim 14, wherein the display device and the control device are integrated together within a single enclosure.

17. The video display transceiver device of claim 16, wherein the display device and the control device are integrated together as a “smart” television device.

18. The video display transceiver device of claim 14, wherein the display device and the control device are integrated as separate devices.

19. The video display transceiver device of claim 18, wherein the control device is integrated as an HDMI stick device.

20. The video display transceiver device of claim 14, wherein the processor is configured to cause the video content stored on the storage device to be made available for one or more other video display transceiver devices to detect and download.
